(19) United States
(12) Patent Application Publication
(10) Pub. No.: US 2012/0241301 A1
(43) Pub. Date: Sep. 27, 2012

(54) SWITCH

(75) Inventors: Shingo Chiba, Makinohara-shi (JP); Tetsuro Takasaki, Makinohara-shi (JP)

(73) Assignee: YAZAKI CORPORATION, Tokyo (JP)

(21) Appl. No.: 13/512,098

(22) PCT Filed: Nov. 25, 2010
(86) PCT No.: PCT/JP2010/071027

§ 371 Date: May 25, 2012

(30) Foreign Application Priority Data
Nov. 25, 2009 (JP) 2009-267837

(51) Int. Cl. H01H 1/02

(52) U.S. Cl. 200/511

(57) ABSTRACT

A switch includes a switch knob, a housing, a push pin, and a rubber contact. The switch knob is supported on the housing in a movable manner by pushed. The push pin is pressed in accordance with a push of the switch knob. The rubber contact elastically deforms when the push pin is pressed. A conductive part of the rubber contact is contacted so as to conductively connect a circuit. The circuit is formed by conductors which are a plurality of wire rods provided in parallel. Ends of the wire rods are protruded in a connector opening provided in the housing as male tabs.

### TECHNICAL FIELD

The invention is related to a switch which is installed in a circuit body.

### BACKGROUND ART

A switch is known in which a switch knob is supported in a housing in movable manner by pushed, and a circuit which is provided in the housing is conductively connected by making a rubber contact deform elastically with a push of the switch knob. For example, a switch 500 in FIG. 8, which is disclosed in PTL 1, includes a base plate 501, a flexible printed circuit board 503, a flexible sheet 505 and a key top 507. Fixed contacts 511 including contacts 511a and 511b are printed to form a pattern on a contact circuit forming part 509 of the flexible printed circuit board 503. A pair of buttons 513 and 513 are formed on the flexible sheet 505. As shown in FIG. 9, a pair of pressing parts 515 and 515 are provided vertically on the lower surface of the key top 507. When the key top 507 is swung, the pressing part 515 at the pressed side presses the button 513, a movable contact 517 which is provided on the back side of the button 513 contacts with the fixed contact 511, and the contacts 511a and 511b are conducted.

### CITATION LIST

### Patent Literature

[PTL 1] JP-A-9-139154

### SUMMARY OF INVENTION

### Technical Problem

However, since the conventional switch 500 uses the flexible printed circuit board 503, the switch cannot be connected with a regular connector. That is, the flexible printed circuit board 503 is first connected to another board which is a relay board, and then connected with the connector. For this reason, the number of components increases, the assembly becomes complicated and the cost increases.

The invention is made in view of the above-mentioned situation, and an object of the invention is to provide a switch so that the number of components can be reduced, the assembly can be simplified and the cost can be reduced.

### Solution to Problem

The above object of the invention is achieved by the following structures.

(1) A switch, comprising:

a switch knob;

a housing on which the switch knob is supported in a movable manner by pushed;

a push pin which is pressed in accordance with a push of the switch knob; and

a rubber contact which elastically deforms when the push pin is pressed,

wherein a conductive part of the rubber contact is contacted so as to conductively connect a circuit,

wherein the circuit is formed by conductors which are a plurality of wire rods provided in parallel, and

wherein ends of the wire rods are protruded in a connector opening provided in the housing as male tabs.

According to the switch, the wire rods can be used instead of the boards, and the boards (the flexible printed circuit board and the relay board) and the additional connector are not required.

(2) The switch according to above (1), wherein

parts of the wire rods where contact with the conductive part become fixed contacts, and

both ends of each of the fixed contact are fixed in a state where the both ends are press fitted into the housing.

According to the switch, the fixed contacts of the wire rods, which the conductive parts of the rubber contacts contact, are held between two ends which are fixed to the housing, and the positions relative to the conductive parts can be precisely held.

(3) The switch according to above (1) or (2), wherein

two of the conductive parts are arranged along with a longitudinal direction of the wire rods, and

two circuits are formed by providing three wire rods in parallel.

According to the switch, the two circuits can be opened and closed since the positions of the two conductive parts are staggered in the longitudinal direction of the wire rods.

(4) The switch according to any one of above (1) to (3), wherein

the switch is used for interior illuminating devices for vehicles.

According to the switch, it is possible to provide inexpensive and small indoor illuminating devices for vehicles.

### Advantageous Effects of Invention

According to the switch of the invention, since the circuit which the rubber contact which elastically deforms due to the push of the switch knob contacts is formed of the plurality of wire rods provided in parallel, and the ends of the wire rods are protruded in the connector opening of the housing as the male tabs, the number of components can be reduced, the assembly can be simplified and the cost can be reduced.

### BRIEF DESCRIPTION OF DRAWINGS

FIG. 1 is an exploded perspective view of a switch according to the invention.

FIG. 2 is an assembled perspective view of the switch shown in FIG. 1.

FIGS. 3A to 3C are explanary figures of the switch according to the invention, in which FIG. 3A is a plan view of the switch, FIG. 3B is a top view of FIG. 3A, FIG. 3C is a right side view of FIG. 3A, and FIG. 3D is a back view of FIG. 3A.

FIG. 4 is an A-A sectional view of FIG. 3A.

FIG. 5 is a perspective view of a rubber contact.

FIGS. 6A to 6C are figures which show patterns of wire rod arrangements, in which FIGS. 6A, 6B and 6C are pattern figures of different wire rod arrangements, respectively.

FIGS. 7A to 7E are explanary procedure figures which show assembling procedures of the switch shown in FIG. 1, in which FIGS. 7A to 7E are figures which explain one of the procedures, respectively.

FIG. 8 is an exploded perspective view of a conventional switch.

FIG. 9 is a sectional view of the switch shown in FIG. 8.

### DESCRIPTION OF EMBODIMENTS

Below, the embodiments of the invention are explained with reference to the figures.

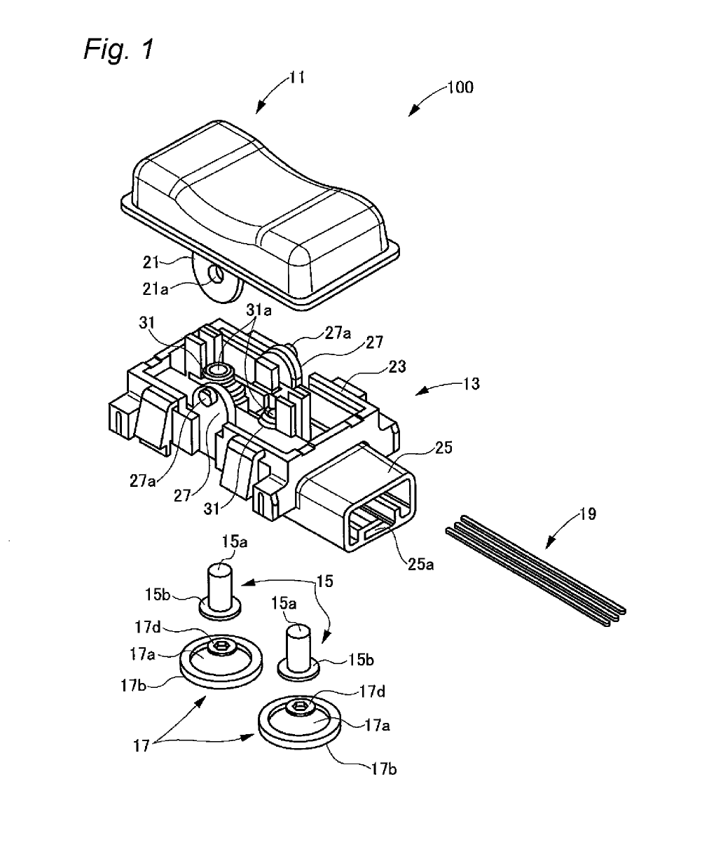

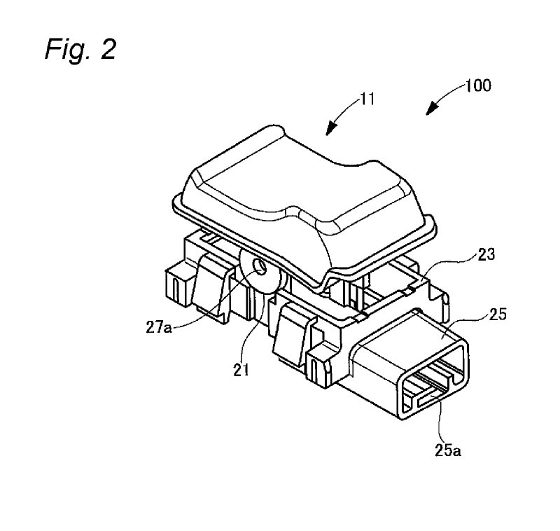

FIG. 1 is an exploded perspective view of a switch according to the invention, and FIG. 2 is an assembled perspective view of the switch shown in FIG. 1. In the embodiments, it is explained that a seesaw switch is used as the switch.

A seesaw switch 100 includes a switch knob 11, a housing 13, push pins 15, rubber contacts 17, and wire rods 19. The switch knob 11 is made of a resin material, and formed to have a substantially rectangular shape. The center of the upper surface of the switch knob 11 is dented, and a pair of engaging plates 21 which have engaging holes 21a are provided vertically on the lower surface of the switch knob 11.

The housing 13 is integrally molded by a resin material, and has a substantially rectangular shape. A connector opening part 25 having a connector opening 25a is integrally coupled to a side surface of the housing body 23 of the housing 13 in the longitudinal direction. A counterpart connector (female connector) not shown in the figure is inserted into and engaged with the connector opening 25.

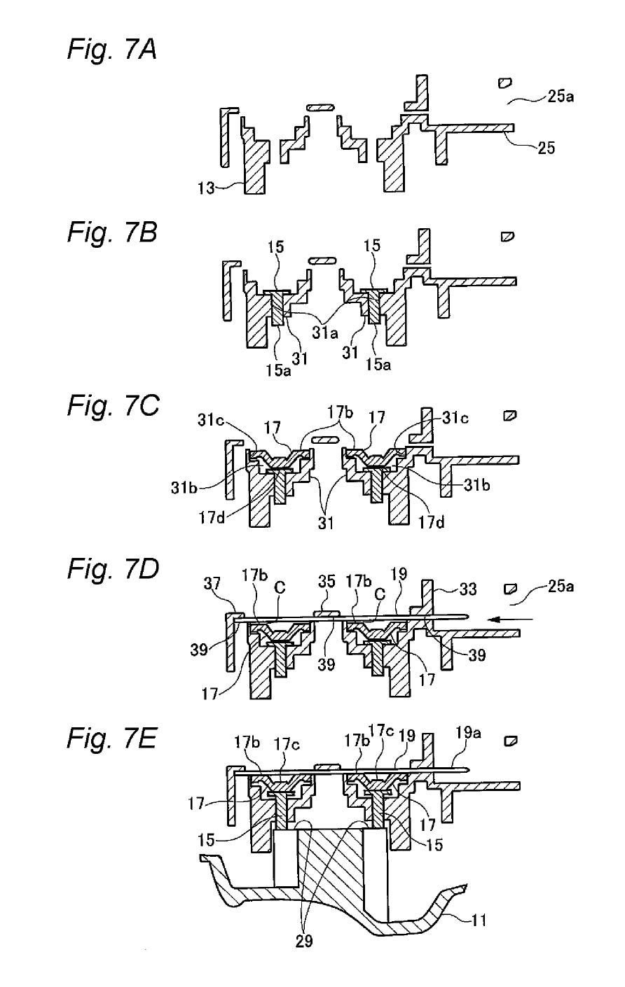

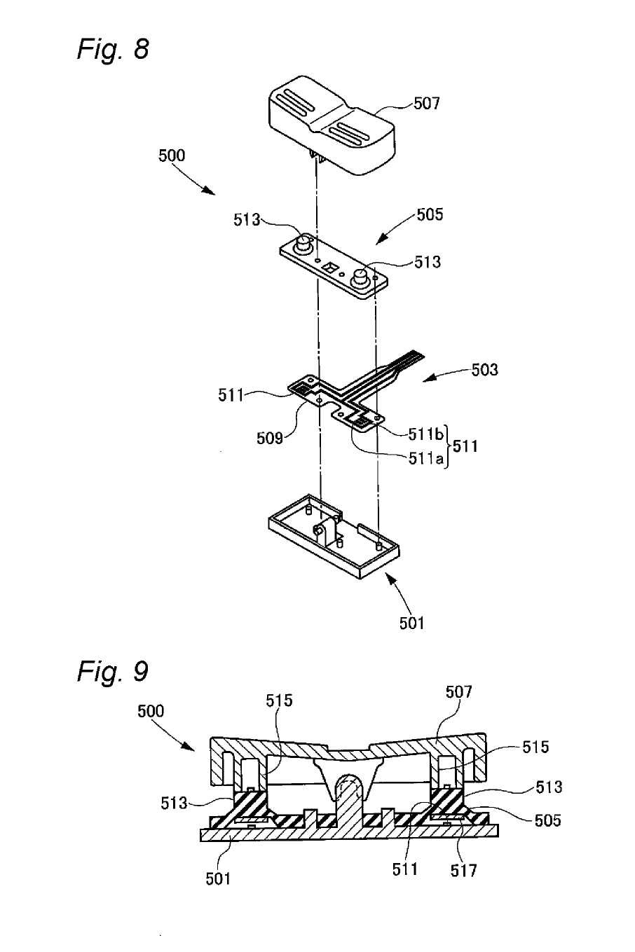

A pair of parallel supporting plates 27 and 27 are provided to stand upright on the upper surface of the housing 13, and shafts 27a which are engaged with the above-mentioned engaging holes 21a protrude from the upper outside surfaces of the supporting plates 27 and 27, respectively. Since the engaging holes 21a are rotatably engaged with the shafts 27a, the center part of the switch knob 11 is swingably supported by the supporting plates 27 and 27 of the housing 13. A pair of pressing parts 29 and 29 (refer to FIG. 7E) are provided on the lower surface of the switch knob 11 on both sides of the engaging plates 21 in the longitudinal direction.

A pair of mountain-like protruding parts 31 and 31 are provided on the upper surface of the housing 13 on both sides of the supporting plates 27 in the longitudinal direction. The protruding part 31 has a through hole 31a at the top part. The through hole 31a opens at the lower surface of the housing 13 by being penetrated. These through holes 31a are arranged to face the pressing parts 29 of the switch knob 11 when the pressing parts 29 of the switch knob 11 are attached to the housing 13.

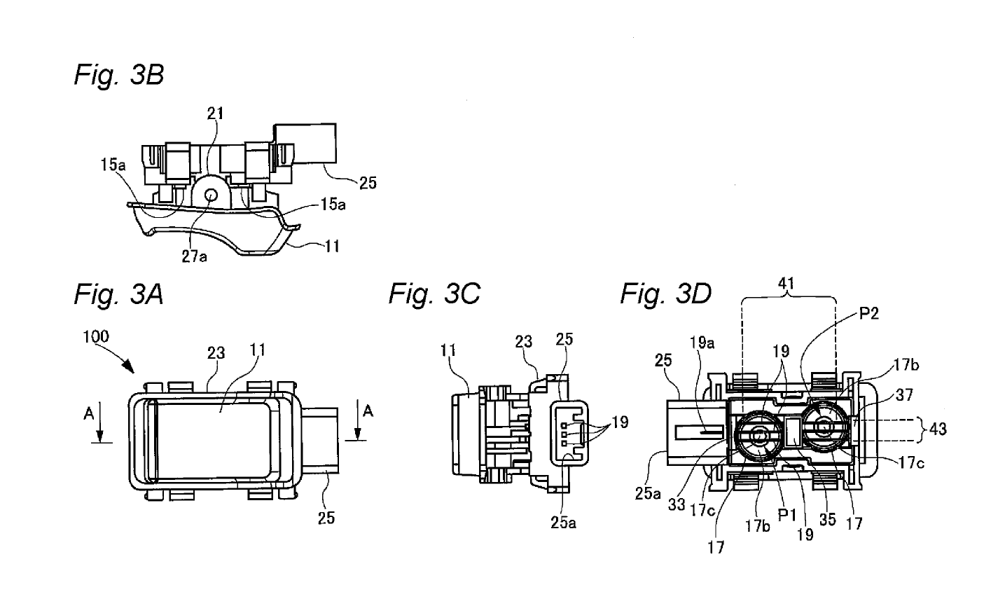

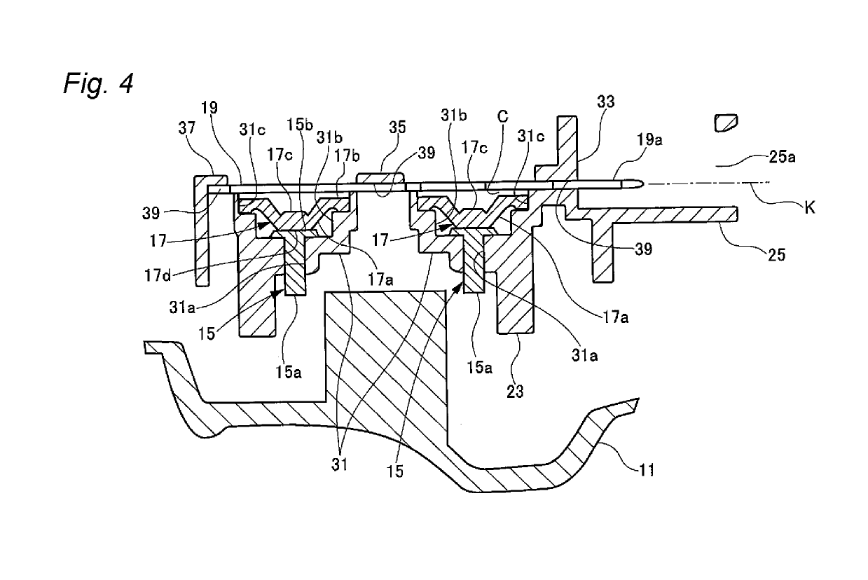

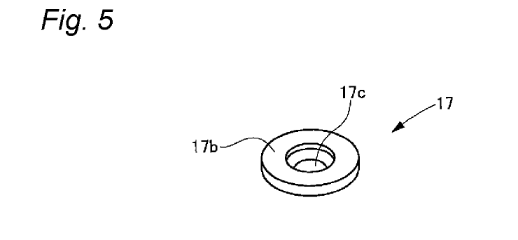

FIG. 3A is a plan view of FIG. 2, FIG. 3B is a top view of FIG. 3A, FIG. 3C is a right side view of FIG. 3A, FIG. 3D is a back view of FIG. 3A, FIG. 4 is an A-A sectional view of FIG. 3A, and FIG. 5 is a perspective view of the rubber contact.

As shown in FIG. 4, an accommodating part 31b is formed at the rear side of the protruding part 31 around the same center as the through hole 31a, and has a diameter larger than that of the through hole 31a. A step-like seat 31c is formed at the opening edge of the accommodating part 31b. These through holes 31a, accommodating parts 31b, and seats 31c are exposed on the lower surface (upper side in FIG. 4) of the housing 13.

The push pin 15 has a shank 15a which is inserted through the through hole 31a of the protruding part 31. The push pin 15 is provided with a flange-like pressing plate 15b at the side opposite to the insertion side of the shank 15a. The outer diameter of the pressing plate 15b is larger than that of the through hole 31a. That is, the pull of the push pin 15 from the through hole 31a upwards (lower side in FIG. 4) is regulated by the pressing plate 15b.

The rubber contacts 17 are respectively arranged in the accommodating parts 31b and 31b into which the push pins 15 are arranged to be respectively inserted. The rubber contacts 17 are made of an elastic material, such as rubber, and flanges 17b are coupled to the opening side of bowl-like bodies 17a. Conductive parts 17c which bulge to have a circular shape shown in FIG. 5 are provided at the deepest parts of the rear sides of the bowl-like bodies 17a. The conductive parts 17c are made of a material with good conductivity, such as gold and carbon. The rubber contact 17 is attached by inserting a top part 17d into the accommodating part 31b and fitting the flange 17b with the seat 31c. The rubber contact 17 which is attached to the rear side of the protruding part 31 as above is arranged so that the top part 17d contacts with the pressing plate 15b of the push pin 15, as shown in FIG. 4.

When the switch knob 11 is swung, the push pin 15 will be pushed down by the pressing part 29 (refer to FIG. 7E), which is interlocked with the switch knob 11. The rubber contact 17 is elastically deformed by a downwards pushing force of the push pin 15 so that the conductive part 17c moves in the same direction (upwards in FIG. 4). That is, the bowl-like body 17a (refer to FIG. 1) is crushed.

Three press fitting and fixing parts 33, 35 and 37, which are protruded towards the upper side in FIG. 4 above the flanges 17b of the rubber contacts 17 which are fitted with the seats 31c, are formed on the lower surface of the housing 13. The rubber contact 17 which is attached to one accommodating part 31b is arranged between the press fitting and fixing parts 33 and 35, and the rubber contact 17 which is attached to the other accommodating part 31b is located between the press fitting and fixing parts 35 and 37.

A plurality of (three in this embodiment) parallel press fitting holes 39 which are penetrated in the longitudinal direction of the housing 13 are drilled in the same pitch through the press fitting and fixing parts 33, 35 and 37, respectively. The extension lines K of these press fitting holes 39 go to the connector opening 25a of the connector opening 25. The press fitting holes 39 are arranged near the flanges 17b of the rubber contacts 17 which are fitted with the seats 31c.

The wire rods 19 which are conductive are press fitted into the press fitting holes 39 of the press fitting and fixing parts 33, 35 and 37, respectively. In this embodiment, the wire rods 19 are formed to have a straight linear shape with the same length, as shown in FIG. 1. Gold, silver, copper, copper alloy or the like can be used for the wire rods 19. Further, a conductive film may be applied by being plated. It is preferable for the wire rods 19 to have, for example, a cross section of rectangular shape. Thus, the contacting property of the wire rods 19 with the conductive parts 17c can be good.

The wire rods 19 are sequentially press fitted and fixed in the press fitting holes 39 of the press fitting and fixing parts 33, 35 and 37 from the connector opening 25a. The three parallel wire rods 19 which are press fitted and fixed in the press fitting hole 39 are arranged to overlap the flanges 17b of the rubber contacts 17, as shown in FIG. 3D. However, the wire rods 19 are arranged to be slightly above the flanges 17b. The distance from the flanges 17b is assumed as a clearance C (refer to FIG. 4). Cracks produced when the press fitted wire rods 19 contact with the rubber contacts 17 can be prevented because the clearance C is secured. After the assembly is completed, the clearance C disappears because the switch knob 11 is attached. In this way, the separation of the rubber contact 17 from the accommodating part 31b will be regulated by the wire rods 19.

The three wire rods 19 which are provided in parallel form a conductor 43 of a circuit 41 shown in FIG. 3D on the lower surface of the housing 13. At the same time, the ends (base ends used in press fitting) 19a of the wire rods 19 are protruded to the connector opening 25a provided in the housing 13 as male tabs. The conductive part 17c contacts the wire rod 19 when the rubber contact 17 is crushed by pushing the switch knob 11.

The contacting parts of the wire rods 19 with the conductive parts 17c are assumed as fixed contacts P1 and P2 shown in FIG. 3D. Both ends of the fixed contacts P1 and the P2 are fixed by being press fitted in the press fitting and fixing parts 33, 35 and 37 of the housing 13. Thus, the both ends of the fixed contacts P1 and P2 which the conductive parts 17c contacts with are fixed to the press fitting and fixing parts 33, 35 and 37 so that the positions relative to the conductive parts 17c can be precisely held.

Since the wire rods 19 are fixed at the both sides which sandwich the fixed contacts P1 and P2, the loads applied on the wire rods 19 in case the rubber contacts 17 are crushed become equal. Therefore, the switch feelings when the switch knob 11 is pushed in any of the swinging directions become equal.

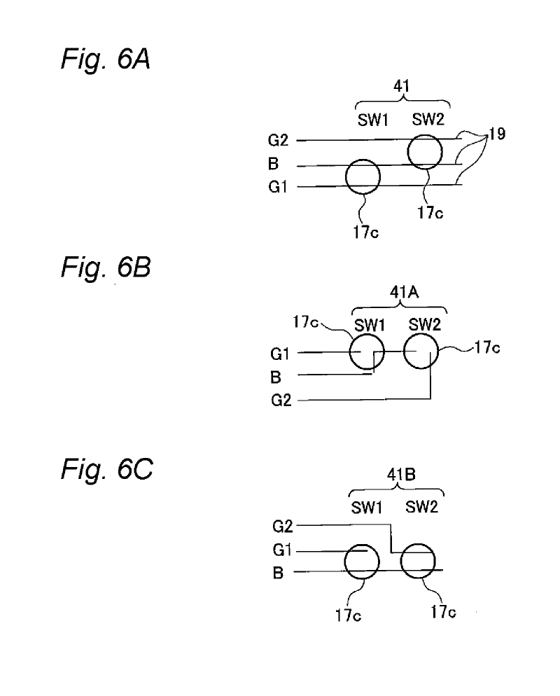

FIGS. 6A, 6B and 6C are pattern figures of different wire rod arrangements.

The fixed contacts P1 and P2 and the conductive parts 17c of the rubber contacts 17 forms switches SW1 and SW2. According to this embodiment, the wire rods 19 are formed to have a straight linear shape as described above. The two conductive parts 17c and 17c are arranged along with the longitudinal direction of the wire rods 19. In this case, as shown in FIG. 3D, the conductive parts 17c and 17c are arranged (staggered arrangement) by being displaced in the spacing pitch direction of the wire rods 19, 19 and 19 so that the conductive parts 17c and 17c contact with two wire rods 19 and 19, respectively.

As shown in FIG. 6A, the three wire rods 19 provided in parallel become a common circuit B and two side circuits G1 and G2 that may be conductively connected with the common circuit B. That is, the circuit 41 which has the switch SW1 which opens and closes the common circuit B and the circuit G1, and the SW2 which opens and close the common circuit B and the circuit G2 are formed. Thus, since the switches SW1 and SW2 are obliquely arranged, the two switches SW1 and SW2 in the circuit 41 can be formed to be available to be opened and closed by using the three wire rods 19 which are not bended.

Further, if the wire rods 19 can be suitably bended at positions where no trouble may occur in press fitting, the circuits 41A and 41B in which the switches SW1 and SW2 are provided can be formed in other wire rod arrangement patterns, as shown in FIGS. 6B and 6C.

Next, an assembling method of the above-mentioned seesaw switch 100 is explained.

FIGS. 7 A to 7E are explanatory procedure figures which show assembling procedures of the seesaw switch shown in FIG. 1.

In order to assemble the seesaw switch 100, as shown in FIG. 7A, the housing 13 is supported upside down, or the posture (posture of FIG. 1) that the switch knob 11 is the upper part is turned over.

As shown in FIG. 7B, the shanks 15a are inserted into the through holes 31a so that the push pins 15 and 15 are arranged to be inserted into the protruding parts 31 and 31, respectively.

As shown in FIG. 7C, the top parts 17d are turned over and the rubber contacts 17 are inserted into the accommodating parts 31b of the protruding parts 31 and 31, respectively. The flanges 17b of the inserted rubber contacts 17 are fitted with the seats 31c.

As shown in FIG. 7D, the wire rods 19 are sequentially press fitted in the press fitting holes 39 of the press fitting and fixing parts 33, 35 and 37 from the connector opening 25a of the connector opening part 25. In this case, the clearances C are formed between the flanges 17b and the wire rods 19, and cracks of the rubber contacts 17 are prevented from being produced.

Finally, the switch knob 11 is swingably supported, as shown in FIG. 2, by engaging the engaging holes 21a (refer to FIG. 1) of the engaging plates 21 provided on the switch knob 11 with the shafts 27a (refer to FIG. 1) of the supporting plates 27 provided on the housing 13. In this case, the switch knob 11 is attached so that the pressing parts 29 and 29 only slightly press the push pins 15. Therefore, the pressed rubber contacts 17 are positioned at predetermined positions since the flanges 17b are butted against the wire rods 19. That is, a predetermined distance (refer to FIG. 3D) between the conductive parts 17c and the fixed contacts P1 and P2 of the wire rods 19 is precisely set. In this way, the seesaw switch 100 is assembled.

In the seesaw switch 100 which has the above-mentioned structure, when the switch knob 11 is swung in either direction around the shafts 27a, the pressing part 29 at the swung side will press the push pin 15. The pressed push pin 15 presses the rubber contact 17; the bowl-like body 17a is crushed due to elastic deformation, and the conductive part 17c of the rubber contact 17 contacts with the fixed contact P1 (or P2). Therefore, in the circuit 41 which the conductive part 17c of the rubber contact 17 contacts, either of the switches SW1 and SW2 is closed. Thus, in the seesaw switch 100, the wire rods 19 can be used instead of the conventional boards (the flexible printed circuit board and the relay board), and the boards and the additional connector are not required. The steps of assembling these unrequired components can be substantially reduced.

The seesaw switch 100 can be suitably used for, for example, indoor illuminating devices for vehicles. Therefore, it is possible to provide inexpensive and small indoor illuminating devices for vehicles.

Therefore, according to the seesaw switch 100 of the embodiment, since the circuit 41 which the rubber contact 17 which elastically deforms due to the push of the switch knob 11 contacts is formed of the plurality of wire rods 19 provided in parallel, and the ends 19a of the wire rods 19 are protruded in the connector opening 25a of the housing 13 as the male tabs, the number of components can be reduced, the assembly can be simplified and the cost can be lowered.

Although the present invention is described in detail with reference to specific embodiments, it is apparent that various modifications and amendments may be made by those skilled in the art without departing from the spirit and scope of the invention.

This application is based on the Japanese patent application No. 2009-267837 filed on Nov. 25, 2009, whose content is incorporated herein by way of reference.

### REFERENCE SIGNS LIST

11 switch knob
13 housing
15 push pin
17 rubber contact
17c conductive part
19 wire rod
19a end of a conductor
25a connector opening
41 circuit
43 conductor
100 seesaw switch
P1 and P2 fixed contact

1. A switch, comprising:
a switch knob;
a housing on which the switch knob is supported in a movable manner by pushed;
a push pin which is pressed in accordance with a push of the switch knob; and
a rubber contact which elastically deforms when the push pin is pressed, wherein a conductive part of the rubber contact is contacted so as to conductively connect a circuit,
wherein the circuit is formed by conductors which are a plurality of wire rods provided in parallel, and
wherein ends of the wire rods are protruded in a connector opening provided in the housing as male tabs.

2. The switch according to claim 1, wherein
parts of the wire rods where contact with the conductive part become fixed contacts, and
both ends of each of the fixed contact are fixed in a state where the both ends are press fitted into the housing.

3. The switch according to claim 1, wherein
two of the conductive parts are arranged along with a longitudinal direction of the wire rods, and
two circuits are formed by providing three wire rods in parallel.

4. The switch according to claim 1, wherein
the switch is used for interior illuminating devices for vehicles.
